(19) United States
(12) Patent Application Publication
(10) Pub. No.: US 2017/0350425 A1
(43) Pub. Date: Dec. 7, 2017

(54) ASSEMBLY METHOD OF A PISTON-CYLINDER GROUP AND A PISTON-CYLINDER GROUP THUS OBTAINED

(71) Applicant: OGNIBENE POWER S.P.A., REGGIO EMILIA (IT)

(72) Inventor: Claudio OGNIBENE, REGGIO EMILIA (IT)

(73) Assignee: OGNIBENE POWER S.P.A., REGGIO EMILIA (IT)

(21) Appl. No.: 15/609,618

(22) Filed: May 31, 2017

(30) Foreign Application Priority Data
Jun. 3, 2016 (IT) 102016000057197

(51) Int. Cl. F15B 15/14

(52) U.S. Cl. CPC F15B 15/1438; F15B 15/1442; F15B 15/1428; F15B 2215/30

(57) ABSTRACT

An assembly method of a piston-cylinder group (10), where the piston-cylinder group (10) includes a cylinder (20) at an end of which a head (40) is fixable, provided with seal gaskets (43). The method includes the steps of: mounting the seal gaskets (43) in appropriate seatings in the head (40); coupling the head (40) with the cylinder (20); and a low-temperature welding of the coupling between the head (40) and the cylinder (20).

### TECHNICAL FIELD

The present invention relates to an assembly method of a piston-cylinder group and a piston-cylinder group obtained thereby.

### BACKGROUND

Piston-cylinder groups are known comprising a cylinder in which a stem is housed. The cylinder is closed at an end thereof by a base to which it is joined by a circumferential weld and has at an opposite end thereof a head to which it is joined by a further circumferential welding.

In a known assembly method of the piston-cylinder group, the head is welded to an end of the cylinder without seal gaskets by means of a conventional welding process and in a second operation the seal gaskets and the stem are inserted and lastly the base is welded to the other end of the cylinder.

This process is followed since the high heat levels caused by the welding operation must be dissipated before inserting the seal gasket, which is generally made of a thermoplastic material, with the purpose of preventing damage thereto.

One of the drawbacks of this known assembly process is that it involves long working times with consequent negative repercussions on production costs.

An aim of the present invention is to provide an assembly method of a piston-cylinder group which enables rapid execution times, with consequent savings on associated costs.

This aim is attained by the characteristics of the invention as recited in the independent claim. The dependent claims delineate preferred and/or particularly advantageous aspects of the invention.

### SUMMARY

The invention in particular relates to an assembly method of a piston-cylinder group, where the piston-cylinder group comprises a cylinder at an end of which a head is fixable, provided with seal gaskets, where the method comprises steps of:

mounting the seal gaskets in appropriate seatings in the head;

coupling the head with the cylinder; and

a low-temperature welding of the coupling between the head and the cylinder.

An advantage of this solution is given by the fact that it enables welding the head to the cylinder with the seal gaskets already inserted in position, maintaining sufficiently low temperatures for avoiding damage thereto.

In an aspect of the invention a low-temperature welding step is included of a base to an end of the cylinder not coupled to the head.

In an aspect of the invention the low-temperature weld between the cylinder and the head and the low-temperature weld between the cylinder and the base are carried out in parallel.

An advantage of this solution is that it enables realising the piston-cylinder group with a rapid and economical process.

The invention further comprises a piston-cylinder group comprising a cylinder at an end of which a head is fixable, provided with seal gaskets, where the head is coupled to the cylinder by means of low-temperature welding.

In a further embodiment of the invention, the piston-cylinder group comprises a base coupled to the cylinder by means of low-temperature welding.

Further characteristics of the invention can be derived from the dependent claims.

### BRIEF DESCRIPTION OF THE DRAWINGS

Further characteristics and advantages of the invention will emerge from a reading of the following description, provided by way of non-limiting example with the aid of the figures illustrated in the appended tables of drawings, in which:

FIG. 1 is an axonometric view of a piston-cylinder group according to an embodiment of the invention;

FIG. 2 is a section view of the piston-cylinder group of FIG. 1;

FIG. 3 is a partly-sectioned lateral view of the piston-cylinder group of FIG. 1;

FIG. 4 is a detail in section of the head of the piston-cylinder group of FIG. 1;

FIG. 5 is a detail in section of the base of the piston-cylinder group of FIG. 1;

FIG. 6 is a larger-scale detail, in section, of FIG. 4, and

FIG. 7 is a block diagram that illustrates the main steps of the assembly method of the piston-cylinder group according to an embodiment of the invention.

### DETAILED DESCRIPTION OF THE PREFERRED EMBODIMENTS

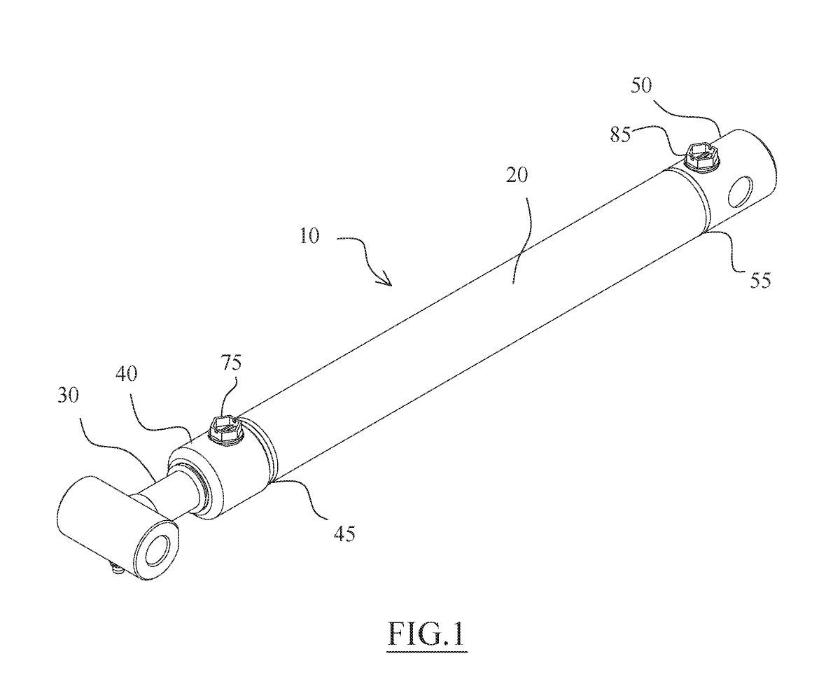

With particular reference to FIG. 1, reference numeral 10 denotes in its entirety the piston-cylinder group according to an embodiment of the invention, which comprises a cylinder 20 in which a stem 30 is housed, an end of which projects from the cylinder through a hole provided in a head 40.

In particular the cylinder 20 is closed at an end thereof by a base 50 to which it is joined by a circumferential weld 55 and has at an opposite end 40 thereof a head to which it is joined by a further circumferential weld 45.

A piston 60 is fixed to an end of the stem 30, which can slide between a proximal position to the base 50 of the cylinder 20 to a position proximal to the head 40 of the cylinder 20.

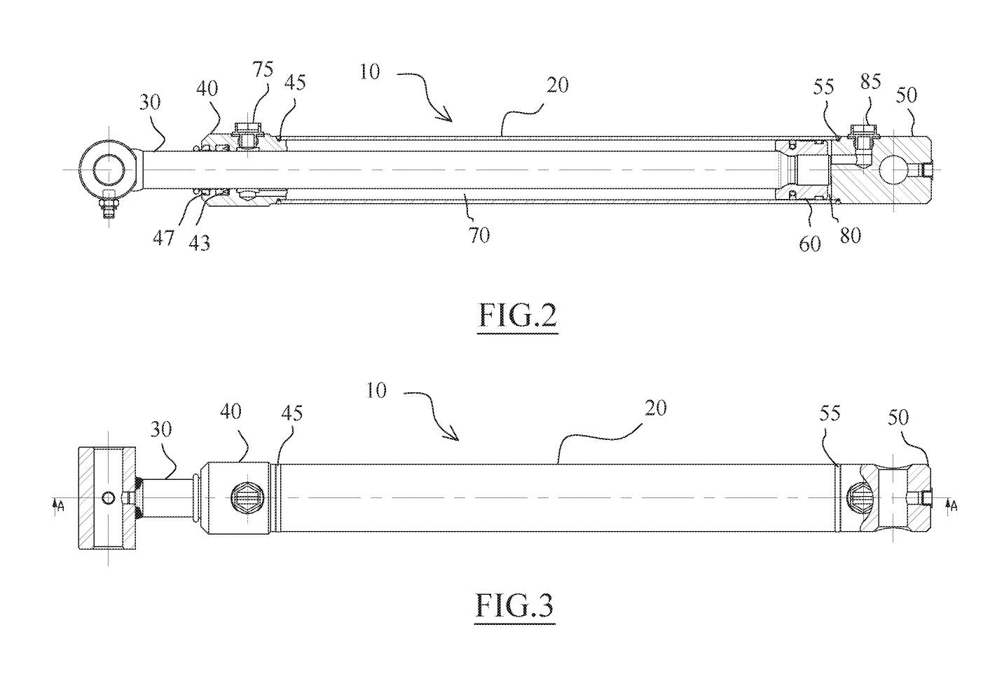

In particular, the piston 60 can slide internally of the cylinder 20. Further, the piston 60 divides the internal volume of the cylinder into two chambers 70 and 80, each of which is supplied with fluid, for example oil, through a conduit denoted respectively by 75 and 85 (FIGS. 2 and 3).

With reference to FIG. 5, the piston 60 has on a lateral surface thereof two annular seatings, wherein one of the annular seatings a seal gasket 62 is housed, while a guide ring 64 is housed in the other annular seating.

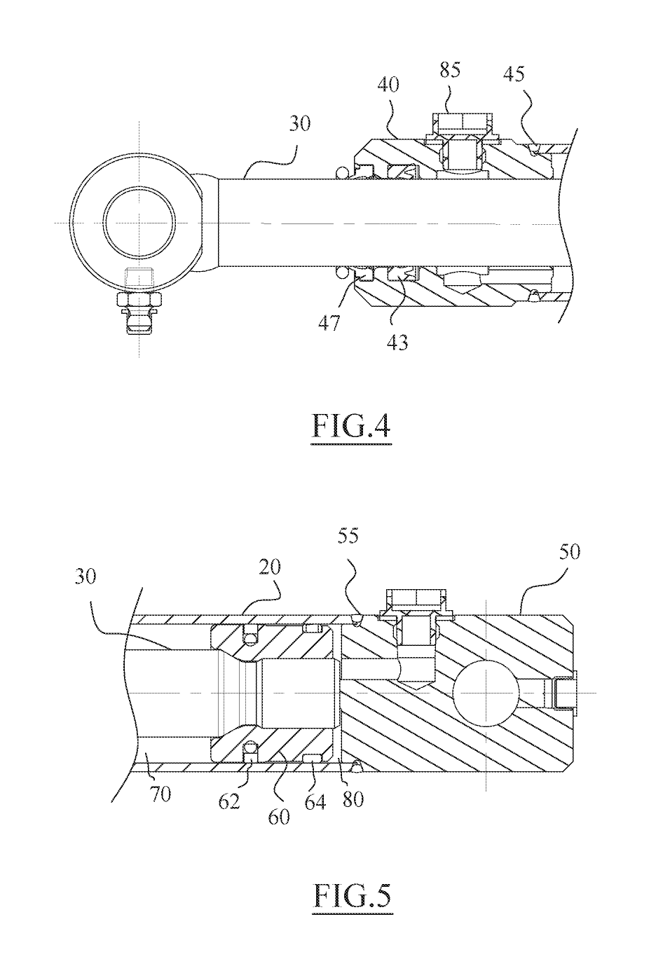

With reference to FIG. 4, the head 40 has on the internal surface thereof two annular seatings, where a seal gasket 43 is housed in one of the annular seatings, while a scraper ring 47 is housed in the other annular seating.

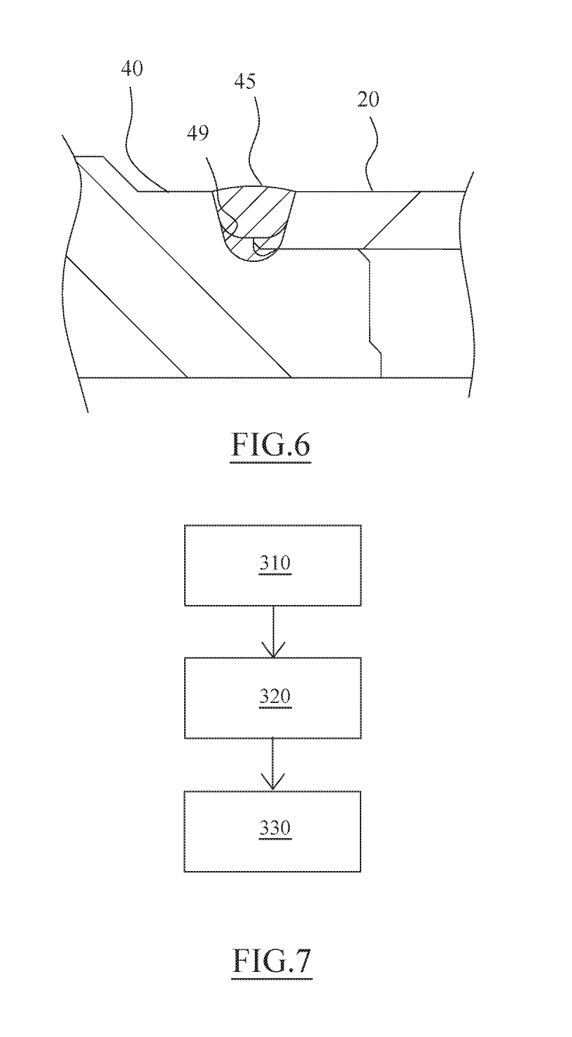

Lastly, FIG. 6 is a larger-scale detail, in section, of FIG. 4, where a caulking 49 can be seen.

In an embodiment of the invention, the circumferential weld 45 which joins the cylinder 20 to the base 40 and/or the circumferential weld 55 joining the cylinder 20 to the head 50 are realised by low-temperature welding, for example by cold metal transfer (CMT).

The welding process, which is of known type, is defined by the alternation of an “arc” step and a “short-circuit” transfer step.

During the arc step, the metal wire is neared to the piece to be welded and fused by means of an arc of current. At the moment when the metal wire fuses and the metal begins falling towards the welding puddle, the short-circuit step begins in which the arc of current is reduced and the metal wire is distanced from the workpiece.

The distancing of the wire from the workpiece facilitates detachment of drops of fused metal from the wire and deposits them in the welding puddle. This method therefore enables obtaining a welding process that is highly controllable, is low-temperature and reduces the energy used during the working process.

FIG. 7 is a block diagram that illustrates the main steps of the assembly method of the piston-cylinder group 10 according to the present invention.

In a first assembly step (block 310) all the components of the piston-cylinder group are assembled.

The piston 60 is provided with the seal gasket 62 and the guide ring 64, while the seal gasket 43 and the scraper 47 are positioned in the appropriate annular seatings of the head 40.

The piston 60 is coupled with the stem 30 and inserted internally of he cylinder 20 at the ends of which the head 40 and the base 50 are positioned.

Once all the components are assembled, the piston-cylinder group 10 is positioned on a welding template and the piston 60 is positioned at the centre of the cylinder 20 (block 320) with the aim of distancing the seal gaskets 62 from the weld joints.

When the piston-cylinder group 10 is positioned on the welding template the low-temperature welding step is begun (block 330).

The welding is performed at the join between the cylinder 20 and the base 50 and the join between the cylinder 20 and the head 40.

In a further embodiment of the invention, only the weld 45 between the cylinder 20 and the head 50 is carried out by low-temperature welding, for example by cold metal transfer CMT, while the weld 55 between the cylinder 20 and the base 50 is carried out by means of another known welding method.

In a further embodiment of the invention, both welds 45 and 55 can be done using CMT. In this particular embodiment the welds can be carried out in succession by use of a single hot wire, or contemporaneously by use of two hot wires which work in parallel on the profiled elements to be welded.

At the end of the low-temperature welding, the piston-cylinder group 10 can be positioned on a bench where thermocouples are present, usable for controlling the cooling of the piston-cylinder group.

In an aspect of the invention, the seal gaskets 43 and 62 can be mounted in the destination position thereof, before the welding step, since by using the described method, the welding temperature does not exceed 65° C. and the integrity of the seal gaskets is preserved.

The present invention is also applicable to piston-cylinder groups having a through-stem where a head 40 provided with seal gaskets 43 is fixed to both ends of the cylinder 20. In this case the piston is fixed at the halfway line of the stem and both the ends of the stem project from the cylinder through holes afforded in the heads 40.

The invention as it is conceived is susceptible to numerous modifications, all falling within the scope of the inventive concept.

Further, all the details can be replaced with other technically-equivalent elements.

In practice the materials used, as well as the contingent shapes and dimensions, can be any according to requirements, without forsaking the scope of protection of the following claims.

1. An assembly method of a piston-cylinder group (10), where the piston-cylinder group (10) comprises a cylinder (20) at an end of which a head (40) is fixable, provided with seal gaskets (43), the method comprising steps of:
mounting the seal gaskets (43) in appropriate seatings in the head (40);
coupling the head (40) with the cylinder (20); and
a low-temperature welding of the coupling between the head (40) and the cylinder (20).

2. The method of claim 1, wherein a low-temperature welding step is included of a base (50) to an end of the cylinder (20) not coupled to the head (40).

3. The method of claim 2, wherein a low-temperature weld (45) between the cylinder (20) and the head (40) and a low-temperature weld (55) between the cylinder (20) and the base (50) are carried out in parallel.

4. The method of claim 1, wherein a stem (30) to which a piston (60) provided with seal gaskets (62) is coupled is inserted in the cylinder (20) before carrying out the low-temperature welding operations.

5. The method of claim 2, wherein a stem (30) to which a piston (60) provided with seal gaskets (62) is coupled is inserted in the cylinder (20) before carrying out the low-temperature welding operations.

6. The method of claim 4, wherein the stem (30) is inserted in the cylinder (20) in such a way that the piston (60) is in a substantially central position internally of the cylinder (20) before carrying out the low-temperature welding operations.

7. The method of claim 5, wherein the stem (30) is inserted in the cylinder (20) in such a way that the piston (60) is in a substantially central position internally of the cylinder (20) before carrying out the low-temperature welding operations.

8. The method of claim 1, wherein the temperature at which the welds are carried out does not exceed 65° C.

9. The method of claim 2, wherein the temperature at which the welds are carried out does not exceed 65° C.

10. The method of claim 1, wherein the low-temperature welding is carried out by cold metal transfer (CMT).

11. The method of claim 2, wherein the low-temperature welding is carried out by cold metal transfer (CMT).

12. A piston-cylinder group (10) comprising a cylinder (20) at an end of which a head (40) is fixable, provided with seal gaskets (43), where the head (40) is coupled to the cylinder (20) by means of low-temperature welding.

13. A piston-cylinder group (10) comprising a base (50) coupled to the cylinder (20) by means of low-temperature welding.
